(19) United States
(12) Patent Application Publication
(10) Pub. No.: US 2010/0020114 A1
(43) Pub. Date: Jan. 28, 2010

(54) DISPLAY DRIVER INTEGRATED CIRCUIT INCLUDING PRE-DECODER AND METHOD OF OPERATING THE SAME

(76) Inventors: Woo-nyoung Lee, Hwaseong-si (KR); Chang-hwe Choi, Yongin-si (KR); Chon-wook Park, Hwaseong-si (KR)

Correspondence Address: F. CHAU & ASSOCIATES, LLC, 130 WOODBURY ROAD, WOODBURY, NY, 11797, US

(21) Appl. No.: 12/500,225

(22) Filed: Jul. 9, 2009

(30) Foreign Application Priority Data
Jul. 24, 2008 (KR) 10-2008-0072431

(51) Int. Cl. G09G 5/10

(52) U.S. Cl. 345/690

(57) ABSTRACT

A display driver integrated circuit (IC) includes a grayscale voltage generator, a main decoder unit, a pre-decoder unit, and an output buffer unit. The grayscale voltage generator is configured to receive at least one gamma reference voltage and generate a plurality of grayscale voltages. The main decoder unit is configured to receive the grayscale voltages and data, decode the data, and selectively output a grayscale voltage based on the decoded result. The pre-decoder unit is configured to decode part of the data and output a precharge voltage. The output buffer unit is configured to sequentially receive an output of the pre-decoder unit and an output of the main-decoder unit, and output grayscale data used for driving a display device.

### CROSS-REFERENCE TO RELATED APPLICATIONS

This application claims priority to Korean Patent Application No. 10-2008-0072431, filed on Jul. 24, 2008, in the Korean Intellectual Property Office, the disclosure of which is incorporated by reference in its entirety herein.

### BACKGROUND

1. Technical Field

The present disclosure relates to a display driver integrated circuit (IC) and a method of operating the same, and more particularly, to a display driver IC including a pre-decoder and a method of operating the same.

2. Discussion of Related Art

Liquid crystal display devices (LCDs) are widely used in notebook computers and monitors. An LCD has a panel including a plurality of pixels for displaying an image. The pixels may be driven with grayscale data provided by a display driver integrated circuit (IC) to display the image on the panel. A conventional display driver IC will now be described with reference to FIG. 1.

FIG. 1 is a block diagram of a conventional display driver IC. Referring to FIG. 1, a conventional display driver IC 10 may include a latch unit 11, a decoder unit 12, an output buffer unit 13, and a grayscale voltage generator 14. The latch unit 11 may externally receive data signals D₁ to Dₓ and output the data signals D₁ to Dₓ to the decoder unit 12 in response to a predetermined clock signal CLK. When the display driver IC 10 includes a number “x” of channels for providing grayscale data to a panel (not shown), the latch unit 11 may receive a number “x” of data signals, each of which has a predetermined number of bits.

The decoder unit 12 may receive the data signals D₁ to Dₓ from the latch unit 11 and decode the data signals D₁ to Dₓ. Also, the decoder unit 12 may receive a number “b” of grayscale voltages VG1 to VGb from the grayscale voltage generator 14. The decoder unit 12 may selectively output a grayscale voltage corresponding to each channel based on a decoded result of the data signals D₁ to Dₓ.

The output buffer unit 13 may receive the grayscale voltages from the decoder unit 12, buffer the grayscale voltages, and output the buffered grayscale voltages as grayscale data Y₁ to Yₓ to the panel. The grayscale voltage generator 14 may externally receive a plurality of gamma reference voltages VGMA1 to VGMAa, divide the gamma reference voltages VGMA1 to VGMAa, and generate the “b” grayscale voltages VG1 to VGb. The grayscale voltage generator 14 may include strings of resistors connected between the gamma reference voltages VGMA1 to VGMAa to enable the generation of the grayscale voltages VG1 to VGb. When each of the data signals D₁ to Dₓ has n bits, the grayscale voltage generator 14 may generate a number 2ⁿ of grayscale voltages VG1 to VGb, where n is a natural number.

FIG. 2A is a circuit diagram of a part of the grayscale voltage generator 14, which may include a string of resistors R1 to R4 and the decoder unit 12. The string may be connected between the first gamma reference voltage VGMA1 and the second gamma reference voltage VGMA2. The decoder unit 12 receives the grayscale voltages VG1 to VG3 from the string of resistors R1 to R4. Buffers receiving the first and second gamma reference voltages VGMA1 and VGMA2 may be located external to the display driver IC 10. The decoder unit 12 may include a plurality of decoders corresponding to respective channels.

FIG. 2B shows grayscale-voltage output characteristics (e.g., slew rates of output voltages) of the respective decoders. Section (a) of FIG. 2B shows an example where a decoder selectively outputs the first grayscale voltage VG1 of FIG. 2A, section (b) of FIG. 2B shows an example where a decoder selectively outputs the second grayscale voltage VG2 of FIG. 2A, and section (c) of FIG. 2B shows an example where a decoder selectively outputs the third grayscale voltage VG3 of FIG. 2A.

As the resolution of a panel increases, the number of switches included in the decoder unit 12 through which a grayscale voltage is transmitted also increases. For example, a grayscale voltage may be transmitted through 10 switch transistors to the output buffer unit 13 to generate a panel with a 10-bit resolution. However, an increase in the number of switches included in the decoder unit 12 may lead to an increase in a resistance-capacitance (RC) delay time of the decoder unit 12.

As shown in FIG. 2B, each of the decoders selectively outputs one of a plurality of grayscale voltages based on the decoded result. The slew rate of a grayscale voltage transmitted to the output buffer unit 13 may be varied according to the selected grayscale voltage. The first and second gamma reference voltages VGMA1 and VGMA2 are transmitted through a predetermined buffer to the display driver IC 10. A grayscale voltage generated by resistors R1 to R4 between the first and second gamma reference voltages VGMA1 and VGMA2 (e.g., the second grayscale voltage VG2 generated between the resistors R2 and R3) has the slowest slew rate among grayscale voltages generated by the resistor string R1 to R4. This is because a node interposed between the resistors R2 and R3 has the highest resistance and parasitic capacitance relative to the other nodes within the resistor string R1 to R4 due to the node being positioned far from the first and second gamma reference voltages VGMA1 and VGMA2. Section (b) of FIG. 2B shows an example where a decoder selectively outputs the second grayscale voltage VG2 to the output buffer unit 13. In section (b), the slew rate of a signal “in” applied to the output buffer unit 13 becomes slower than in sections (a) and (c) and thus, the slew rate of a signal “out” output by the output buffer unit 13 also becomes slower than in sections (a) and (c).

Accordingly, in the conventional display driver IC 10, as the resolution of the panel increases, the RC delay time of the decoder unit 12 also increases. As a result, grayscale data output by the display driver IC 10 have nonuniform slew rates.

Thus, there is a need for display drivers and methods of driving displays that can generate more uniform slew rates.

### SUMMARY

A display driver IC according to an exemplary embodiment of the present invention includes: a grayscale voltage generator, a main decoder unit, a pre-decoder unit, and an output buffer unit. The grayscale voltage generator is configured to receive at least one gamma reference voltage and generate a plurality of grayscale voltages. The main decoder unit is configured to receive the grayscale voltages and data, decode the data, and selectively output a grayscale voltage based on the decoded result. The pre-decoder unit is configured to decode part of the data and output a precharge voltage. The output buffer unit is configured to sequentially receive an output of the pre-decoder unit and an output of the main-decoder unit, and output grayscale data used for driving a display device.

The pre-decoder unit may include a buffer unit configured to receive some of the generated grayscale voltages, buffer the received grayscale voltages, and output the buffered grayscale voltages. The display driver IC may further include a switch unit configured to transmit outputs of the main decoder unit and the pre-decoder unit to the output buffer unit.

The switch unit may include: a first switch unit and a second switch unit. The first switch unit may be connected between the main decoder unit and the output buffer unit and configured to transmit the selected grayscale voltage to an input terminal of the output buffer unit in response to a first control signal. The second switch unit may be connected between the pre-decoder unit and the output buffer unit and configured to transmit the precharge voltage to the input terminal of the output buffer unit in response to a second control signal. The second control signal may be an inverted signal of the first control signal.

The grayscale voltage generator may receive a number “a” of gamma reference voltages, includes a number “a−1” of resistor strings connected between the gamma reference voltages, divides the gamma reference voltages, and generates a number 2ⁿ of grayscale voltages (e.g., “a” and “n” are integers). The main decoder unit may include first decoders in a number equal to the number of data channels of the display driver IC, and each of the first decoders may decode n-bit data and output a grayscale voltage based on the decoded result.

The pre-decoder unit may include second decoders in a number equal to the number of the data channels of the display driver IC, and each of the second decoders may receive significant m-bit data out of n-bit data and a number 2^{m} of grayscale voltages out of the 2ⁿ grayscale voltages, decode the m-bit data, and output one of the 2^{m} grayscale voltages as the precharge voltage, where “m” is an integer less than “n”.

A number “a−1” of grayscale voltages may be transmitted to each of the second decoders, where the “a−1” grayscale voltages are generated from each of the number “a−1” of resistor strings. Each of the “a−1” resistor strings may transmit a grayscale voltage to each of the second decoders, which corresponds to an intermediate value between two gamma reference voltages connected to both ends of the corresponding resistor strings.

Each of the second decoders may include a number 2^{m} of buffers, which are respectively connected to the 2^{m} grayscale voltages. The buffers may buffer the corresponding grayscale voltages and output the buffered voltages. The output buffer unit includes output buffers in a number equal to the number of the data channels of the display driver IC. The display driver IC may further include: a first switch and a second switch. The first switch may be connected between an output terminal of the first decoder and an input terminal of the output buffer and configured to be switched on and off in response to a first control signal. The second switch may be connected between an output terminal of the second decoder and the input terminal of the output buffer and configured to be switched on and off in response to a second control signal. The second and first control signals may be sequentially enabled, and after the precharge voltage is transmitted to the input terminal of the output buffer, an output of the first decoder may be transmitted to the input terminal of the output buffer.

A display driver IC according to an exemplary embodiment of the present invention includes: a grayscale voltage generator, a main decoder unit, a pre-decoder unit, and a buffer unit. The grayscale voltage generator is configured to receive a number “a” of gamma reference voltages and generate a number “b” of grayscale voltages, where “a” and “b” are integers that are least 2. The main decoder unit includes a plurality of first decoders, where each first decoder is configured to selectively output a grayscale voltage corresponding to an n-bit data signal. The pre-decoder unit includes a plurality of second decoders, where each second decoder is connected to a number “c” of grayscale voltages out of the “b” grayscale voltages and configured to receive an m-bit data signal out of the n-bit data signal and selectively output a grayscale voltage corresponding to the m-bit data signal. The numbers “c”, “b”, “m”, and “n” are integers, “c” is less than “b”, and “m” is less than “n”. The buffer unit includes buffers interposed between the grayscale voltage generator and the second decoders and connected respectively to the “c” grayscale voltages.

A method of operating a display driver IC according to an exemplary embodiment of the present invention includes: decoding a significant m-bit data signal of an n-bit data signal input to the display driver IC, outputting a grayscale voltage generated by one of a number “a−1” of resistor strings as a precharge voltage based on a decoded result of the m-bit data signal, decoding the n-bit data signal, and outputting one of a number “b” of grayscale voltages based on a decoded result of the n-bit data signal. The “a−1” resistor strings are connected between a number “a” of gamma reference voltages. The “b” grayscale voltages are generated from the “a−1” resistor strings and correspond to “b” grayscale values.

### BRIEF DESCRIPTION OF THE DRAWINGS

Exemplary embodiments of the present invention will be more clearly understood from the following detailed description taken in conjunction with the accompanying drawings in which:

FIG. 1 is a block diagram of a conventional display driver integrated circuit (IC);

FIGS. 2A and 2B are detailed circuit diagrams of the conventional display driver IC shown in FIG. 1;

FIG. 3 is a block diagram of a display driver IC according to an exemplary embodiment of the present invention;

FIG. 4 is a block diagram of the display driver IC shown in FIG. 3 according to an exemplary embodiment of the present invention;

FIG. 5 is a circuit diagram of the display driver IC shown in FIG. 3 according to an exemplary embodiment of the present invention; and

FIG. 6 is a signal waveform diagram showing operating characteristics of the display driver IC shown in FIG. 3, according to an exemplary embodiment of the present invention.

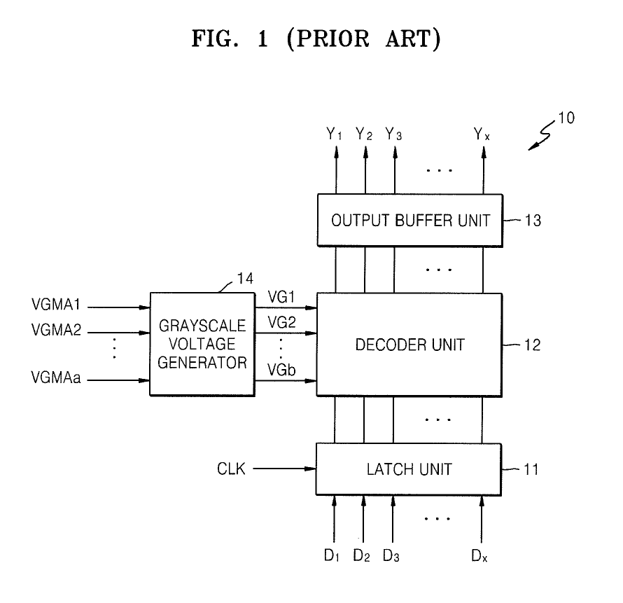

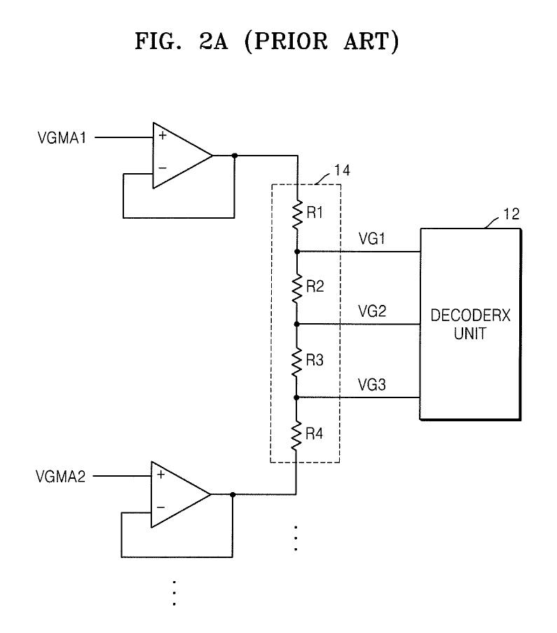

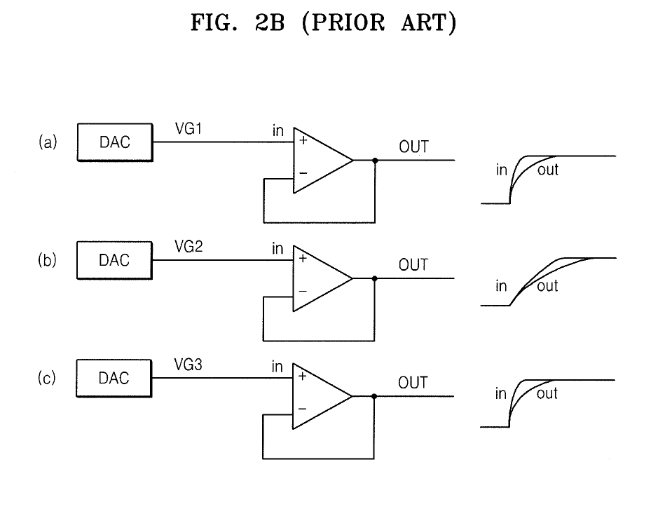

### DETAILED DESCRIPTION OF EXEMPLARY EMBODIMENTS

The present invention will be described more fully hereinafter with reference to the accompanying drawings, in which exemplary embodiments are shown. The same reference numerals are used to denote the same elements throughout the specification.

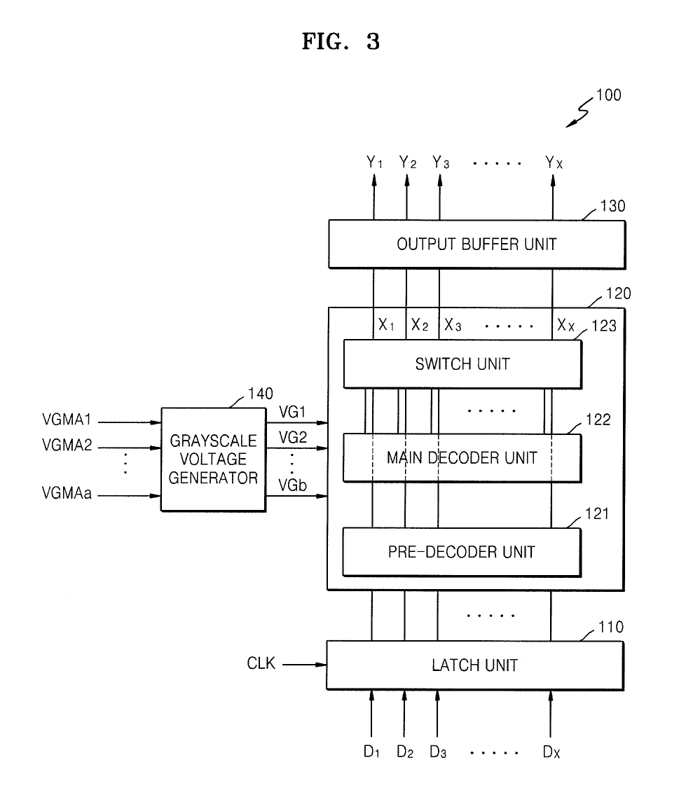

FIG. 3 is a block diagram of a display driver integrated circuit (IC) according to an exemplary embodiment of the present invention. Referring to FIG. 3, a display driver IC 100 may include a latch unit 110, a decoder unit 120, an output buffer unit 130, and a grayscale voltage generator 140. The decoder unit 120 may include a pre-decoder unit 121, a main decoder unit 122, and a switch unit 123. Although the switch unit 123 is illustrated as being included in the decoder unit 120, it may be located between the decoder unit 120 and the output buffer unit 130. Further, although the pre-decoder unit 121 and the main decoder unit 122 are illustrated as being included in the same circuit block (e.g., the decoder unit 120), they may be included in different circuit blocks.

The latch unit 110 may externally receive data signals D₁ to Dₓ and output the data signals D₁ to Dₓ to the decoder unit 120 in response to a predetermined clock signal CLK. When the display driver IC 100 includes a number “x” of data channels for providing grayscale data to a panel (not shown), the latch unit 110 may receive a number “x” of data signals D₁ to Dₓ, where each has a predetermined number of bits (e.g., n bits).

The grayscale voltage generator 140 may externally receive a plurality of gamma reference voltages VGMA1 to VGMAa, divide the gamma reference voltages VGMA1 to VGMAa, and generate a number “b” of grayscale voltages VG1 to VGb. The grayscale voltage generator 140 may include one or more resistor strings connected between the gamma reference voltages VGMA1 to VGMAa to generate the grayscale voltages VG1 to VGb. When each of the data signals D₁ to Dₓ has the n bits, the grayscale voltage generator 140 may divide the gamma reference voltages VGMA1 to VGMAa and generate a number 2ⁿ of grayscale voltages VG1 to VGb.

The decoder unit 120 may receive the data signals D₁ to Dₓ and the “b” grayscale voltages VG1 to VGb. The main decoder unit 122 may include first decoders (not shown) in a number equal to the number of the data channels of the display driver IC 100. When the display driver IC 100 includes the number “x” of data channels as described above, the main decoder unit 122 may include a number “x” of first decoders.

Each of the first decoders may receive a corresponding n-bit data signal and the “b” (e.g., 2ⁿ) grayscale voltages VG1 to VGb. The first decoders may selectively output one of the grayscale voltages VG1 to VGb based on a decoded result of the received data signal. The selected grayscale voltage may be transmitted to one input terminal of the switch unit 123.

The pre-decoder unit 121 may include a number “x” of second decoders corresponding to the number “x” of data channels, and each of the second decoders may receive a partial-bit data signal (e.g., an m-bit data signal, where “m” is an integer less than “n”) of the n-bit data signal and part of the grayscale voltages VG1 to VGb. For example, an m-bit data signal of the n-bit data signal may be transmitted to each of the second decoders. For example, the m-bit data signal may be m most significant bits, m least significant bits, or m other bits of the n-bit data signal. When each of the second decoders receives the m-bit data signal, a number 2^{m} of grayscale voltages out of the grayscale voltages VG1 to VGb may be transmitted to each of the second decoders.

Each of the second decoders may decode the m-bit data signal and selectively output a corresponding grayscale voltage. The selected grayscale voltage may be transmitted to another input terminal of the switch unit 123. The grayscale voltage output by each of the second decoders may serve as a precharge voltage used for precharging an input terminal of the output buffer unit 130.

The pre-decoder unit 121 may receive grayscale voltages that are vulnerable to a resistance-capacitance (RC) delay time out of the grayscale voltages VG1 to VGb generated by the grayscale voltage generator 140. The grayscale voltage generator 140 may include a plurality of resistor strings (not shown), and gamma reference voltages may be transmitted to both ends of each resistor string. For example, a grayscale voltage generated by a middle resistor out of serially connected resistors included in the resistor string (e.g., a grayscale voltage that is approximately intermediate between the gamma reference voltages transmitted to both the ends of the resistor strings) may be transmitted to the pre-decoder 121.

Grayscale voltages transmitted to the pre-decoder unit 121 may be transmitted through a predetermined buffer (not shown) to the pre-decoder unit 121. The buffer may be included in the pre-decoder unit 121 or connected between the grayscale voltages and the pre-decoder unit 121.

The switch unit 123 may include first and second switches (not shown) corresponding to each of the data channels. The first switch may receive an output of the first decoder and transmit the output of the first decoder to the output buffer unit 130 in response to a first control signal. Further, the second switch may receive an output of the second decoder and transmit the output of the second decoder to the output buffer unit 130 in response to a second control signal. For example, the first and second switches may be alternately switched on and off.

The output buffer unit 130 may selectively receive grayscale voltages X₁ to Xₓ from the pre-decoder unit 121 and the main decoder unit 122. The output buffer unit 130 may buffer the received grayscale voltages X₁ to Xₓ and output grayscale data Y₁ to Yₓ used for driving a display device (e.g., driving the panel of the display device). The input terminal of the output buffer unit 130 may be precharged beforehand in response to the grayscale voltage output by the pre-decoder unit 121. Thereafter, the output buffer unit 130 may receive the grayscale voltage output by the main decoder unit 122, buffer the received grayscale voltage, and output the buffered voltage.

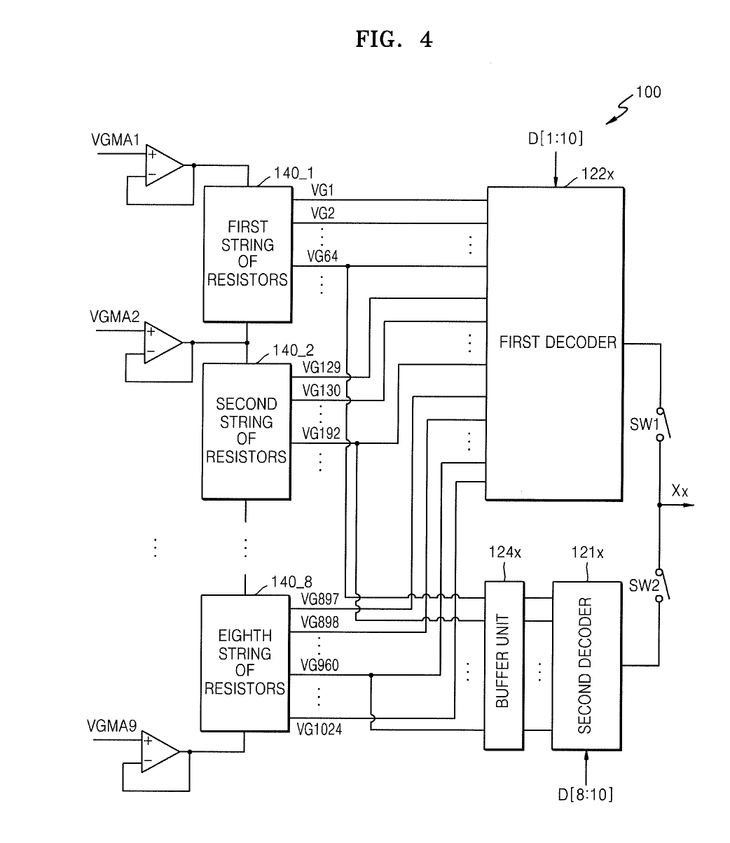

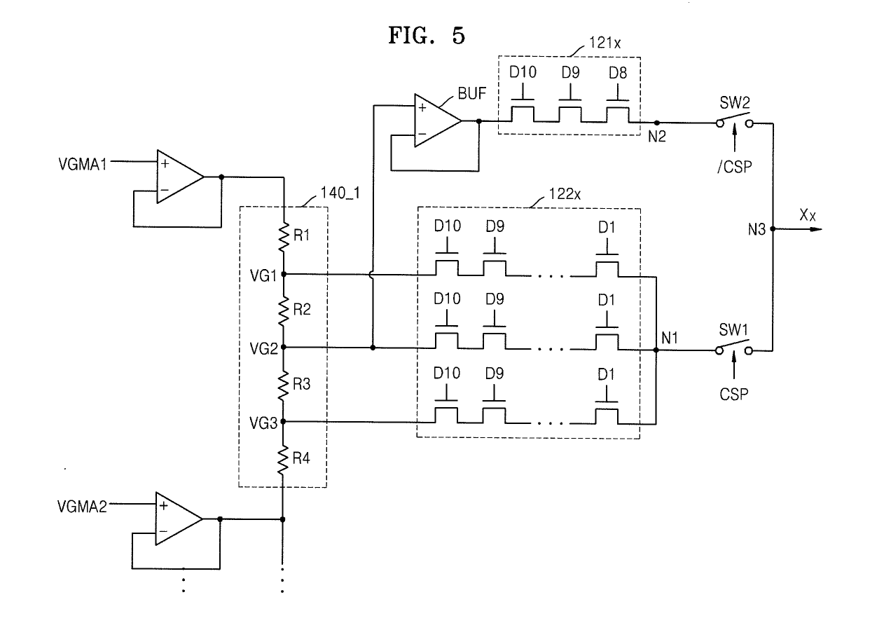

Operation of a display driver IC according to an exemplary embodiment of the present invention will now be described in detail with reference to FIGS. 4 and 5. FIG. 4 is a block diagram of the display driver IC shown in FIG. 3 according to an exemplary embodiment of the present invention. The grayscale voltage generator 140 may include a plurality of resistor strings, which may receive a plurality of gamma reference voltages, divide the gamma reference voltages, and generate grayscale voltages. When the grayscale voltage generator 140 receives a number “a” of gamma reference voltages, it may include a number “a−1” of resistor strings. For example, when the grayscale voltage generator 140 receives 9 gamma reference voltages VGMA1 to VGMA9, it may include 8 resistor strings 140_1 to 140_8. Buffers illustrated between the gamma reference voltages VGMA1 to VGMA9 and the grayscale voltage generator 140 may be located external to the display driver IC 100.

Each of the resistor strings 140_1 to 140_8 may include a plurality of serially connected resistors. For example, when an n-bit data signal corresponding to each channel includes 10 bits, the grayscale voltage generator 140 may generate 2¹⁰ or 1024 grayscale voltages VG1 to VG1024 due to the voltage division of the resistor strings 140_1 to 140_8.

A first decoder 122x shown in FIG. 4 may be an x-th first decoder of a plurality of first decoders included in the main decoder unit 122 shown in FIG. 3. The first decoder 122x may receive a 10-bit data signal D[1:10] and the 1024 grayscale voltages VG1 to VG1024. The first decoder 122x may selectively output one of the 1024 grayscale voltages VG1 to VG1024 based on a decoded result of the 10-bit data signal D[1:10]. The selected grayscale voltage may be transmitted to the first switch SW1.

A second decoder 121x shown in FIG. 4 may be an x-th second decoder of a plurality of second decoders included in the pre-decoder unit 121 shown in FIG. 3. The second decoder 121x may receive a partial-bit data signal (e.g., a 3-bit data signal D[8:10]) of the 10-bit data signal D[1:10]. Further, the second decoder 121x may receive some grayscale voltages (e.g., 8 grayscale voltages) of the 1024 grayscale voltages VG1 to VG1024. The second decoder 121x may selectively output one of the 8 grayscale voltages based on a decoded result of the 3-bit data signal D[8:10]. The selected grayscale voltage may be transmitted to the second switch SW2. The first and second switches SW1 and SW2 may be alternately switched on and off so that the output of the first decoder 122x or the output of the second decoder 121x may be transmitted as an input signal Xx to the output buffer unit 130.

For example, the 3-bit data signal D[8:10] transmitted to the second decoder 121x may include the 3 most or least significant bits of the 10-bit data signal D[1:10]. Further, the 8 grayscale voltages transmitted to the second decoder 121x may be respectively generated by the 8 resistor strings 140_1 to 140_8. For example, a grayscale voltage, which is approximately intermediate between the first and second gamma reference voltages VGMA1 and VGMA2, among the grayscale voltages generated by the first resistor string 140_1 may be transmitted to the second decoder 121x. Further, a grayscale voltage, which is approximately intermediate between the second and third gamma reference voltages VGMA2 and VGMA3, among the grayscale voltages generated by the second resistor string 140_2 may be transmitted to the second decoder 121x. In the above-described manner, one of grayscale voltages generated by each of the 8 resistor strings 140_1 to 140_8 may be transmitted to the second decoder 121x.

The 8 grayscale voltages transmitted to the second decoder 121x may be transmitted through a buffer unit 124x to the second decoder 121x. The buffer unit 124x may include 8 buffers (not shown) corresponding respectively to the 8 grayscale voltages.

The slew rates of grayscale voltages generated by the respective resistor strings 140_1 to 140_8 may be nonuniform. In particular, an intermediate-level grayscale voltage has a low slew rate out of the grayscale voltages generated by the respective resistor strings 140_1 to 140_8. According to an exemplary embodiment of the present invention, one of the grayscale voltages transmitted to the second decoder 121x and buffered by a predetermined buffer may be used to precharge the input terminal of the output buffer unit 130. As a result, the slew rate of the intermediate-level grayscale voltage of the grayscale voltages generated by the respective resistor strings 140_1 to 140_8 may be increased, so that the slew rates of the grayscale voltages can be uniformized.

When one of the 1024 grayscale voltages VG1 to VG1024 is selected in response to the 10-bit data signal D[1:10], information on the resistor strings from which the selected grayscale voltage is generated can be determined using the significant 3-bit data signal D[8:10]. For example, when a grayscale voltage generated by a first resistor string 140_1 is selected by the first decoder 122x, the second decoder 121x may selectively output a grayscale voltage, which is generated by the first resistor string 140_1 and buffered, to precharge the input terminal of the output buffer unit 130. The second decoder 121x may output a precharge voltage to precharge the input terminal of the output buffer unit 130. The precharge voltage may have a level equal to or close to that of a grayscale voltage used for displaying an image on the actual panel. The precharge voltage may be a grayscale voltage generated by the same resistor strings. The second decoder 121x may then transmit a grayscale voltage output by the first decoder 122x to the input terminal of the output buffer unit 130, thereby enabling the input terminal of the output buffer unit 130 to be finely controlled to a grayscale voltage used for driving the actual panel.

In a similar manner to the above description, a grayscale voltage generated by a second string 140_2 of resistors may be selected in response to the 10-bit data signal D[1:10] corresponding to a predetermined channel. For example, when 3 significant bits of the 10-bit data signal D[1:10] have a value of 001, the first decoder 122x may selectively output one of the grayscale voltages VG129, VG130, VG131 . . . generated by the second resistor string 140_2 according to the states of 7 less significant bits D[1:7]. The second decoder 121x may decode the 3 significant bits D[8:10] and selectively output one of the 8 buffered grayscale voltages transmitted by the respective 8 resistor strings 140_1 to 140_8 based on the decoded result. When the 3 significant bits D[8:10] have a value of 001 as described above, the second decoder 121x may selectively output a grayscale voltage transmitted by the second resistor string 140_2.

When the display driver IC 100 starts to output the grayscale data Y₁ to Yₓ, the first switch SW1 is turned off and the second switch SW2 is turned on. As the second switch SW2 is turned on, the output of the second decoder 121x may be transmitted through the second switch SW2 and input as a precharge voltage to the input terminal of the output buffer unit 130. Since the output of the second decoder 121x is a buffered grayscale voltage, the slew rate of a signal applied to the input terminal of the output buffer unit 130 may be increased. Further, since the output of the second decoder 121x is generated by the same resistor strings from which a grayscale voltage selected as actual grayscale data is generated, the input terminal of the output buffer unit 130 may be precharged to a voltage level equal to or close to the grayscale voltage corresponding to the actual grayscale data.

After the precharging, the first switch SW1 is turned on and the second switch SW2 is turned off. As the first switch SW1 is turned on, the output of the first decoder 122x is transmitted through the first switch SW1 to the input terminal of the output buffer unit 130. Due to the grayscale voltage output by the first decoder 122x, the input terminal of the output buffer unit 130 may be controlled to a voltage level corresponding to actual grayscale data.

FIG. 5 is a circuit diagram of the display driver IC shown in FIG. 3 according to an exemplary embodiment of the present invention. A plurality of grayscale voltages may be generated by the first resistor string 140_1 connected between the first and second gamma reference voltages VGMA1 and VGMA2. FIG. 5 illustrates the first resistor string 140_1 generating only first through third grayscale voltages VG1, VG2, and VG3 for brevity. The first decoder 122x may include a plurality of switch transistors corresponding to the entire grayscale voltages generated by the grayscale voltage generator 140. FIG. 5 illustrates the first decoder 122x including only switch transistors corresponding to the first through third grayscale voltages VG1, VG2, and VG3 for brevity. Second decoders 121x and buffers BUF may be provided in numbers equal to the number of the resistor strings included in the grayscale voltage generator 140. FIG. 5 illustrates only a single buffer BUF and switch transistors corresponding to the first resistor string 140_1 for brevity.

In one example, it is assumed that 3 significant bits of the 10-bit data signal D[1:10] corresponding to a predetermined data channel correspond to “000”, and the second grayscale voltage VG2 of the first through third grayscale voltages VG1, VG2, and VG3 has a value that is approximately intermediate between the first and second gamma reference voltages VGMA1 and VGMA2.

The second grayscale voltage VG2 may be transmitted through the predetermined buffer BUF to the second decoder 121x. The second decoder 121x may decode a significant 3-bit data signal D[8:10] and output a buffered second grayscale voltage VG2 through an output terminal N2 of the second decoder 121x to the second switch SW2. When a second control signal /CSP is enabled, the buffered second grayscale voltage VG2 may be transmitted through a node N3 and input as an input signal Xₓ to the input terminal of the output buffer unit 130. Thus, the input terminal of the output buffer unit 130 may be precharged to a voltage level corresponding to the second grayscale voltage VG2.

The first decoder 122x may decode a 10-bit data signal D[1:10]. For example, when the first decoder 122x decodes the 1-bit data signal D[1:10] and selectively outputs the third grayscale voltage VG3, the decoder 122x may output the third grayscale voltage VG3 through the output terminal N1 of the first decoder 122x to the first switch SW1 due to the switch operation of the switch transistors. After a predetermined precharge period, when the second control signal /CSP is disabled, the second switch SW2 may be turned off. When a first control signal CSP is enabled, the first switch SW1 may be turned on. Thus, the third grayscale voltage VG3 may be transmitted through the node N3 and input as the input signal Xₓ to the input terminal of the output buffer unit 130. As a result, the input terminal of the output buffer unit may be controlled to a level of the third grayscale voltage VG3 corresponding to actual grayscale data.

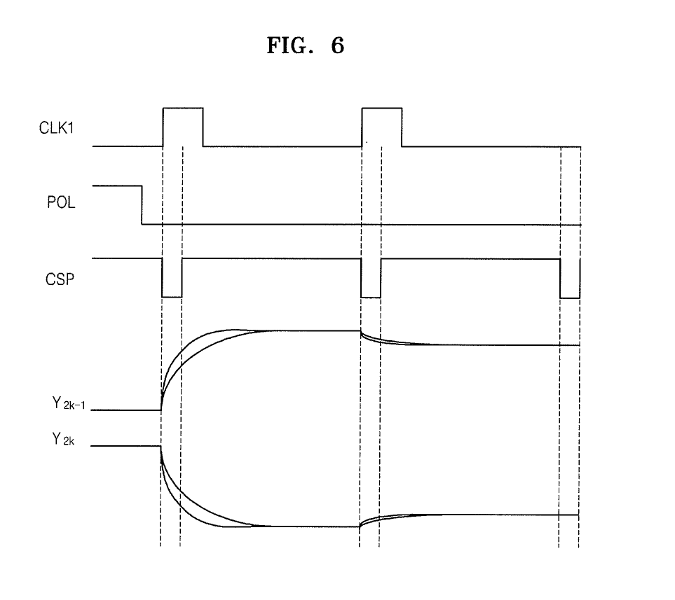

FIG. 6 is a signal waveform diagram showing operating characteristics of the display driver IC shown in FIG. 3, according to an exemplary embodiment of the present invention. The output buffer unit 130 of the display driver IC 100 may start to output signals in response to a clock signal CLK1. An output of the pre-decoder unit 121 may be transmitted to the output buffer unit 130 in response to an additional control signal CSP for a predetermined period. Before a grayscale voltage corresponding to actual grayscale data is transmitted to the output buffer unit 130, the output of the pre-decoder unit 121 may be transmitted to the output buffer unit 130 to precharge the input terminal of the output buffer unit 130. For example, when both the first switch SW1 connected to an output terminal of the main decoder unit 122 and the second switch SW2 connected to an output terminal of the pre-decoder unit 121 include an NMOS transistor, the first switch SW1 may be turned off in response to a low-level first control signal CSP, while the second switch SW2 may be turned on in response to a second control signal /CSP, which is an inverted signal of the low-level first control signal CSP. Thus, the output of the pre-decoder unit 121 may be transmitted to the output buffer unit 130 during a low period of the first control signal CSP to precharge the input terminal of the output buffer unit 130.

After the precharge period, the first control signal CSP may be set to a high level, so that the first switch SW1 may be turned on in response to the high-level first control signal CSP, while the second switch SW2 may be turned off in response to a low-level second control signal /CSP. Thus, an output of the main decoder unit 122 (e.g., a grayscale voltage corresponding to actual grayscale data) may be transmitted to the output buffer unit 130 during a high period of the first control signal CSP.

From among signals shown in FIG. 6, a signal POL denotes a polarity control signal, a signal Y₂ₖ₋₁ denotes grayscale data output by an odd-numbered channel of the output buffer unit 130, and a signal Y₂ₖ denotes grayscale data output by an even-numbered channel of the output buffer unit 130. A non-uniformity in slew rate between grayscale data may become more problematic when the polarity control signal POL makes a level transition, which inverts the levels of grayscale data output by respective channels of the output buffer unit 130. However, due to the precharge operation of the pre-decoder unit 121 according to at least one exemplary embodiment of the present invention, the slew rates of grayscale data Y₂ₖ₋₁ and Y₂ₖ increase as illustrated with the dotted lines. The current driving capability of a grayscale voltage that is vulnerable to the RC delay characteristic may be improved using an additional driver circuit (e.g., a buffer). As a result, RC delay times of vulnerable grayscales can be reduced, thereby uniformizing the slew rates of the grayscale voltages.

While the present invention has been particularly shown and described with reference to exemplary embodiments thereof, it will be understood that various changes in form and details may be made therein without departing from the spirit and scope of the disclosure.

What is claimed is:

1. A display driver integrated circuit (IC) comprising:
a grayscale voltage generator configured to receive at least one gamma reference voltage and generate a plurality of grayscale voltages;
a main decoder unit configured to receive the grayscale voltages and data, decode the data, and selectively output a grayscale voltage based on the decoded result;
a pre-decoder unit configured to decode part of the data and output a precharge voltage; and
an output buffer unit configured to sequentially receive an output of the pre-decoder unit and an output of the main decoder unit, and output grayscale data used for driving a display device.

2. The display driver IC of claim 1, wherein the pre-decoder unit includes a buffer unit configured to receive part of the generated grayscale voltages, buffer the received grayscale voltages, and output the buffered grayscale voltages.

3. The display driver IC of claim 2, further comprising a switch unit configured to transmit outputs of the main decoder unit and the pre-decoder unit to the output buffer unit.

4. The display driver IC of claim 3, wherein the switch unit comprises:
a first switch unit connected between the main decoder unit and the output buffer unit and configured to transmit the selected grayscale voltage to an input terminal of the output buffer unit in response to a first control signal; and
a second switch unit connected between the pre-decoder unit and the output buffer unit and configured to transmit the precharge voltage to the input terminal of the output buffer unit in response to a second control signal.

5. The display driver IC of claim 4, wherein the second control signal is an inverted signal of the first control signal.

6. The display driver IC of claim 1, wherein the grayscale voltage generator receives a number “a” of the gamma reference voltages, includes a number “a−1” of resistor strings connected between the gamma reference voltages, divides the gamma reference voltages, and generates a number 2ⁿ of grayscale voltages, wherein “a” and “n” are integers,
and the main decoder unit includes first decoders in a number equal to a number of data channels of the display driver IC, and each of the first decoders decodes n-bit data and outputs a grayscale voltage based on the decoded result.

7. The display driver IC of claim 6, wherein the pre-decoder unit includes second decoders in a number equal to the number of the data channels of the display driver IC,
and each of the second decoders receives significant m-bit data out of n-bit data and a number 2^{m} of the grayscale voltages out of the 2ⁿ grayscale voltages, decodes the m-bit data, and outputs one of the 2^{m} grayscale voltages as the precharge voltage, wherein “m” is an integer less than “n”.

8. The display driver IC of claim 7, wherein a number “a−1” of grayscale voltages is transmitted to each of the second decoders, wherein the “a−1” grayscale voltages are generated from the “a−1” resistor strings.

9. The display driver IC of claim 8, wherein each of the “a−1” resistor strings transmits a grayscale voltage to each of the second decoders, wherein the grayscale voltage corresponds to an intermediate value between two gamma reference voltages connected to both ends of the corresponding resistor strings.

10. The display driver IC of claim 7, wherein each of the second decoders includes a number 2^{m} of buffers connected respectively to the 2^{m} grayscale voltages and the buffers are configured to buffer the corresponding grayscale voltages and output the buffered voltages.

11. The display driver IC of claim 7, wherein the output buffer unit includes output buffers in a number equal to the number of the data channels of the display driver IC,
wherein the display driver IC further comprises:
a first switch connected between an output terminal of the first decoder and an input terminal of the output buffer and configured to be switched on and off in response to a first control signal; and
a second switch connected between an output terminal of the second decoder and the input terminal of the output buffer and configured to be switched on and off in response to a second control signal.

12. The display driver IC of claim 11, wherein the second and first control signals are sequentially enabled, and after the precharge voltage is transmitted to the input terminal of the output buffer, an output of the first decoder is transmitted to the input terminal of the output buffer.

13. A display driver integrated circuit (IC) comprising:
a grayscale voltage generator configured to receive a number “a” of gamma reference voltages and generate a number “b” of grayscale voltages, wherein “a” and “b” are integers that are least 2;
a main decoder unit including a plurality of first decoders, each first decoder configured to selectively output a grayscale voltage corresponding to an n-bit data signal;
a pre-decoder unit including a plurality of second decoders, each second decoder connected to a number “c” of grayscale voltages out of the “b” grayscale voltages and configured to receive an m-bit data signal out of the n-bit data signal and selectively output a grayscale voltage corresponding to the m-bit data signal, wherein “c”, “b”, “m”, and “n” are integers, “c” is less than “b”, and “m” is less than “n”; and
a buffer unit including buffers between the grayscale voltage generator and the second decoders and connected respectively to the “c” grayscale voltages.

14. The display driver IC of claim 13, further comprising an output buffer unit configured to sequentially receive an output of the main decoder unit and an output of the pre-decoder unit and output grayscale data used for driving a display device.

15. The display driver IC of claim 14, further comprising a plurality of switch units, each switch unit comprising:
a first switch connected to an output terminal of the first decoder and configured to be controlled in response to a first control signal; and
a second switch connected to an output terminal of the second decoder and configured to be controlled in response to a second control signal.

16. The display driver IC of claim 15, wherein when the second switch is turned on, an input terminal of the output buffer unit is precharged to a grayscale voltage output by the second decoder,
and after the input terminal of the output buffer unit is precharged, when the first switch is turned on, a grayscale voltage output by the first decoder is transmitted to the input terminal of the output buffer unit.

17. A method of operating a display driver integrated circuit (IC), the method comprising:
decoding a significant m-bit data signal of a n-bit data signal input to the display driver IC;
outputting a grayscale voltage from one of a number “a−1” of resistor strings as a precharge voltage based on a decoded result of the m-bit data signal, wherein the “a−1” resistor strings are connected between a number “a” of gamma reference voltages;
decoding the n-bit data signal; and
outputting one of a number “b” of grayscale voltages based on a decoded result of the n-bit data signal, wherein the “b” grayscale voltages are generated from the “a−1” resistor strings and correspond to “b” grayscale values.

18. The method of claim 17, wherein the decoding of the m-bit data signal comprises a pre-decoder unit decoding the m-bit data signal based on receiving the m-bit data signal and a number “a−1” of grayscale voltages generated by each of the “a−1” strings of resistors,
and the decoding of the n-bit data signal comprises a main decoder unit decoding the n-bit data signal based on receiving the n-bit data signal and the “b” grayscale voltages.

19. The method of claim 18, wherein the precharge voltage output based on the decoded result of the m-bit data signal and the grayscale voltage output based on the decoded result of the n-bit data signal are generated from the same resistor string.

20. The method of claim 18, further comprising transmitting a grayscale voltage having an intermediate level out of the grayscale voltages generated by each of the resistor strings to the pre-decoder unit.
